(19) United States
(12) Patent Application Publication
(10) Pub. No.: US 2024/0407042 A1
(43) Pub. Date: Dec. 5, 2024

(54) SYSTEMS AND METHODS FOR CONNECTED MODE DISCONTINUOUS RECEPTION USING SHORT CYCLES

(71) Applicant: Telefonaktiebolaget LM Ericsson (PUBL), Stockholm (SE)

(72) Inventors: Ari Kangas, LIDINGÖ (SE); Magnus Persson, SOLLENTUNA (SE)

(21) Appl. No.: 18/693,209

(22) PCT Filed: Sep. 20, 2021
(86) PCT No.: PCT/SE2021/050901

§ 371 Date: Mar. 19, 2024

(51) Int. Cl. H04W 76/28; H04L 5/00; H04W 28/02

(52) U.S. Cl. CPC H04W 76/28; H04L 5/0048; H04W 28/0278

(57) ABSTRACT

A method by a network node is provided for controlling a DRX state of a wireless device configured with a long DRX cycle and in a connected state. The method includes transmitting, to the wireless device PDCCH for scheduling DL or UL data transmission. At a first time, the network node transmits new user data on a PDSCH or receives new user data on a first PUSCH. At a second time, the network node receives a second PUSCH that includes only a BSR with a value that is zero and transmits a DRX Command MAC CE to the wireless device when no pending SRs or PUSCH transmission exist for the wireless device and at least one of: a set time has elapsed after user data was transmitted on the PDSCH or received on the first PUSCH, or a set time elapsed before reception of the second PUSCH.

### TECHNICAL FIELD

The present disclosure relates, in general, to wireless communications and, more particularly, systems and methods for Connected Mode Discontinuous Reception (C-DRX) using short cycles.

### BACKGROUND

The evolution of mobile networks (4G and 5G) during the last decades has enabled very high bit rates and short response times on mobile devices, which may be referred to as User Equipment (UE). Already in 4G networks it is possible to reach 1Gbs UE throughput, which enables very fast downloading of, for example, streaming videos. 5G networks with typical bandwidths of several hundred MHz of bandwidth further increase the possible bit rates and reduces latency.

The increased bandwidth also increases, however, power consumption by a UE since power consumption typically scales with bandwidth. This is true not only for applications requiring high bit rates but also for short status updates or chatty applications since the mobile still needs to monitor the control channels for incoming data, typically on higher bandwidths than what was typical in 4G networks (100 MHz instead of 20 MHz). As a result, methods to reduce the power consumption have become increasingly important in 5G networks.

When a UE is not in active data transfer mode, the UE is typically in a so-called Radio

Resource Control (RRC) idle state, where the UE monitors paging channels and performs measurements to find the best cells to which to connect. In this state, power consumption is typically low and the UE can save battery by switching off the UE's receiver in-between paging monitoring and measurement occasions. When the UE has data to transfer or receives a paging message from the network, the UE connects to the network and transfers to a RRC connected state.

The UE in RRC connected mode is typically expected to monitor a Physical Dedicated Control Channel (PDCCH) for downlink (DL) and/or uplink (UL) grants every slot/subframe. The PDCCH contains information about DL data transmission to be received on the Physical Downlink Shared Channel (PDSCH) and allocation of UE resources for uplink data transmission on the Physical Uplink Dedicated Shared Channel (PUSCH). The PDCCH can be located in a plurality of locations in a configured search space. However, monitoring PDCCH is a major source of battery consumption for a UE during connected mode. Therefore, 3^{rd} Generation Partnership Project (3GPP) has defined features to relax the monitoring requirements during periods when no data transmission is ongoing. One example of such a method is the Connected Mode Discontinuous Reception (C-DRX) functionality which is controlled by a number of parameters:
drx-onDurationTimer: the duration at the beginning of a Discontinuous Reception (DRX) cycle.
drx-SlotOffset: the delay before starting the drx-onDuration Timer
drx-InactivityTimer: the duration after the PDCCH occasion in which a PDCCH indicates a new UL or DL transmission for the Medium Access Control (MAC) entity. drx-RetransmissionTimerDL (per DL Hybrid Automatic Repeat Request (HARQ) process except for the broadcast process): the maximum duration until a DL retransmission is received
drx-RetransmissionTimerUL (per UL HARQ process): the maximum duration until a grant for UL retransmission is received.
drx-LongCycleStartOffset: the Long DRX cycle and drx-StartOffset which defines the subframe where the Long and Short DRX cycle starts.
drx-ShortCycle (optional): the Short DRX cycle.
drx-ShortCycleTimer (optional): the duration the UE shall follow the Short DRX cycle.
drx-HARQ-RTT-TimerDL (per DL HARQ process except for the broadcast process): the minimum duration before a DL assignment for HARQ retransmission is expected by the MAC entity
drx-HARQ-RTT-TimerUL (per UL HARQ process): the minimum duration before a UL HARQ retransmission grant is expected by the MAC entity

FIG. 1 illustrates an example of a basic C-DRX scheme. The UE monitors PDCCH during on-duration or when the DRX inactivity timer or a retransmission timer is running. The rules for starting and stopping the relevant timers are:
1. If the PDCCH indicates a new transmission (DL or UL):
   start or restart drx-InactivityTimer
2. If the PDCCH indicates a DL transmission.
   start the drx-HARQ-RTT-TimerDL for the corresponding HARQ process after the end of the corresponding transmission carrying the DL HARQ feedback.
   stop the drx-RetransmissionTimerDL for the corresponding HARQ process
3. If a drx-HARQ-RTT-TimerDL expires:
   if the data of the corresponding HARQ process was not successfully decoded: start the drx-RetransmissionTimerDL for the corresponding HARQ process

Only the long DRX cycle operation is illustrated in FIG. 1, but it is also possible to configure a short cycle together with the long cycle. This provides a way to gradually move a UE to a less active monitoring state. The long cycles are useful to reduce the power consumption during the time period before the UE is released from the RRC connected state to RRC idle (or inactive).

3GPP 38.321 v 16.4.0 describes the transition between short and long cycles as follows:
If drx-InactivityTimer expires and if the Short DRX cycle is configured:
   start or restart drx-ShortCycleTimer in the first symbol after the expiry of drx-InactivityTimer.
   use the Short DRX cycle
If drx-ShortCycleTimer expires:
   use the Long DRX cycle

FIG. 2 illustrates the use of short DRX cycles in combination with a long DRX cycle as provided in 3GPP 38.321 v 16.4.0.

There currently exist certain challenge(s), however. For example, as described above, the inactivity timer is started when the UE detects a new DL or UL transmission. However, in some cases, this transmission may not be related to user data transmission but instead contain only control information. For example, the PDCCH may contain a Channel State Information (CSI) request along with an UL grant so that the UE may transmit a buffer status report (BSR) on PUSCH along with the CSI report. Also, the UE may be configured by RRC to send BSR regularly and may then utilize its configured uplink Scheduling Request (SR) resources to request PUSCH resources for transmitting the BSR. If such requests are sent regularly, and if the UE has emptied its buffer (BSR=0), the UE is kept awake longer time that necessary with resulting increased battery usage. FIG. 3 illustrates an example scenario when a CSI request may keep a UE active longer than necessary.

### SUMMARY

To address the foregoing problems with existing solutions, systems, methods, and techniques are disclosed that include not starting or restarting timers when a wireless device such as a UE, which has a BSR of zero, transmits or receives user data. In certain embodiments, timers may be proprietary timers that are internal to a network node and/or UE. Solutions, systems, methods, and techniques are also disclosed for configuring the wireless device via RRC signaling or Medium Access Control-Control Element (MAC CE) to no restart an inactivity timer when the wireless device has a BSR of zero and transmits or receives user data.

According to certain embodiments, a method by a network node is provided for controlling a DRX state of a wireless device in a connected state. The wireless device is configured with a long DRX cycle. The method includes transmitting, to the wireless device, PDCCH for scheduling downlink or uplink data transmission. At a first time, the network node transmits, to the wireless device, new user data on a PDSCH or receives, from the wireless device, new user data on a first PUSCH. At a second time that is after the first, the network node receives a second PUSCH that includes only a BSR with a value that is zero. The network node transmits a DRX Command MAC CE to the wireless device when no pending scheduling requests or PUSCH transmission exist for the wireless device and at least one of: a set time has elapsed after user data was transmitted on the PDSCH or received on the first PUSCH, or a set time elapsed before reception of the second PUSCH.

According to certain embodiments, a method by a network node is provided for controlling a DRX state of a wireless device in a connected state. The wireless device is configured with a long DRX cycle. The method includes transmitting, to the wireless device, a PDCCH for scheduling downlink or uplink data transmission. The network node receives, from the wireless device, PUSCH according to the PDCCH. The network node transmits, to the wireless device, a message indicating that the wireless device is not to restart an DRX inactivity timer when the PUSCH transmission contains a Buffer Status Report, BSR, with a value of 0 and when no scheduling requests, SR, are pending and when no additional PUSCH transmissions are scheduled.

According to certain embodiments, a method by a wireless device is provided for controlling a DRX operation while in a connected state and being configured with a long DRX cycle. The method includes monitoring a PDCCH for scheduled DL or UL data. The wireless device transmits a PUSCH according to the PDCCH. The wireless device receives, from a network node, a message indicating that that the wireless device is not to restart an DRX inactivity timer when the PUSCH transmission contains a BSR with a value of 0 and when no SR are pending and when no additional PUSCH transmissions are scheduled.

According to certain embodiments, a network node is provided for controlling a DRX state of a wireless device in a connected state and being configured with a long DRX cycle. The network node is adapted to transmit, to the wireless device, PDCCH for scheduling downlink or uplink data transmission. At a first time, the network node is adapted to transmit, to the wireless device, new user data on the PDSCH or receive, from the wireless device, new user data on a first PUSCH. At a second time that is after the first, the network node is adapted to receive a second PUSCH that includes only a BSR with a value that is zero. The network node is further adapted to transmit a DRX Command MAC CE to the wireless device when no pending scheduling requests or PUSCH transmission exist for the wireless device and at least one of: a set time has elapsed after the new user data was transmitted on the PDSCH or received on the first PUSCH, or a set time elapsed before reception of the second PUSCH.

According to certain embodiments, a network node is provided for controlling a DRX state of a wireless device in a connected state and configured with a long DRX cycle. The network node is adapted to transmit, to the wireless device, a PDCCH for scheduling downlink or uplink data transmission. The network node is adapted to receive, from the wireless device, PUSCH according to the PDCCH. The network node is adapted to transmit, to the wireless device, a message indicating that the wireless device is not to restart an DRX inactivity timer when the PUSCH transmission contains a BSR with a value of 0 and when no SRs are pending and when no additional PUSCH transmissions are scheduled.

According to certain embodiments, a wireless device is provided for controlling a DRX operation while in a connected state and while being configured with a long DRX cycle. The wireless device is adapted to monitor a PDCCH for scheduled DL or UL data. The wireless device transmits a PUSCH according to the PDCCH. The wireless device is adapted to receive, from a network node, a message indicating that that the wireless device is not to restart an DRX inactivity timer when the PUSCH transmission contains a BSR with a value of 0 and when no SR are pending and when no additional PUSCH transmissions are scheduled.

Certain embodiments of the present disclosure may provide one or more technical advantages. For example, certain embodiments may provide a technical advantage of greatly reducing UE power consumption in 4G and 5G systems that use A-CSI reporting on PUSCH including inactivity timer triggering data grant.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example of a basic C-DRX scheme;

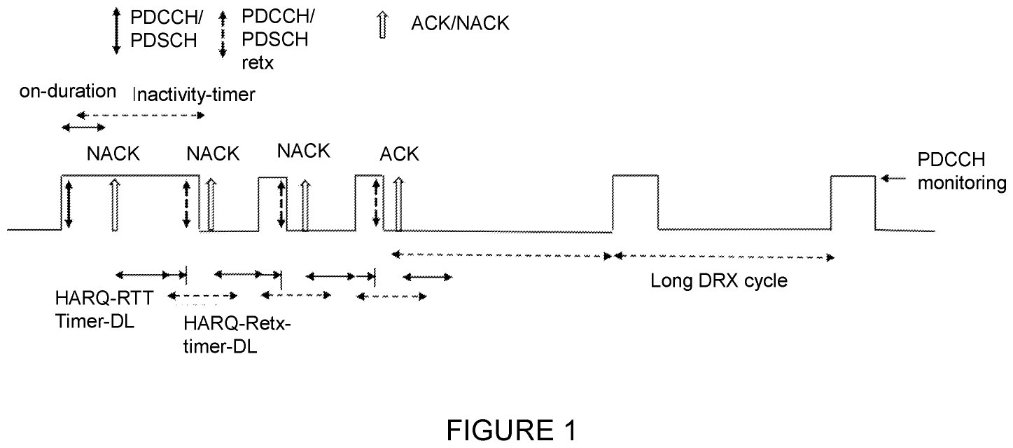

FIG. 2 illustrates the use of short DRX cycles in combination with a long DRX cycle as provided in 3GPP 38.321 v 16.4.0;

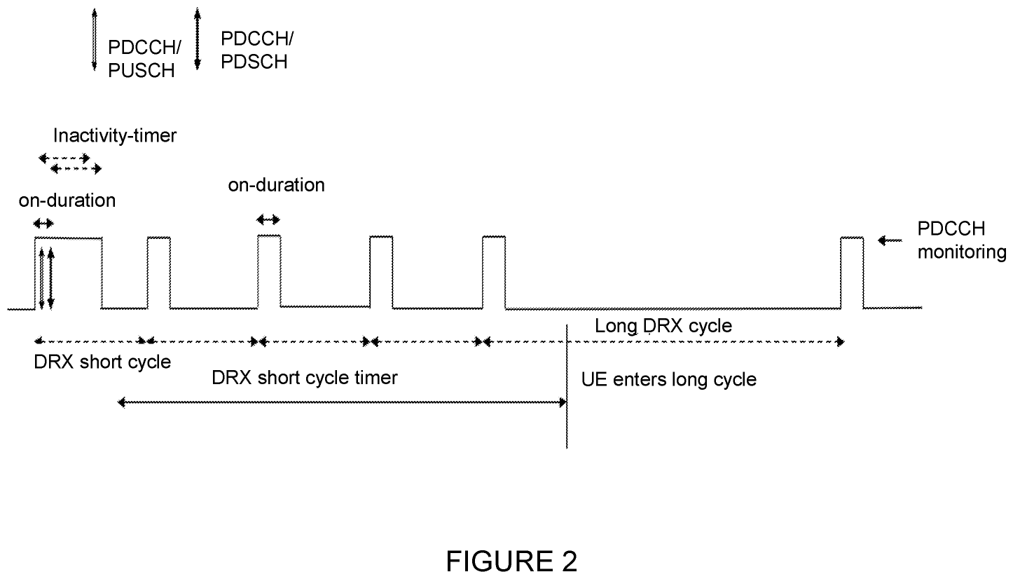

FIG. 3 illustrates an example scenario when a CSI request may keep a UE active longer than necessary;

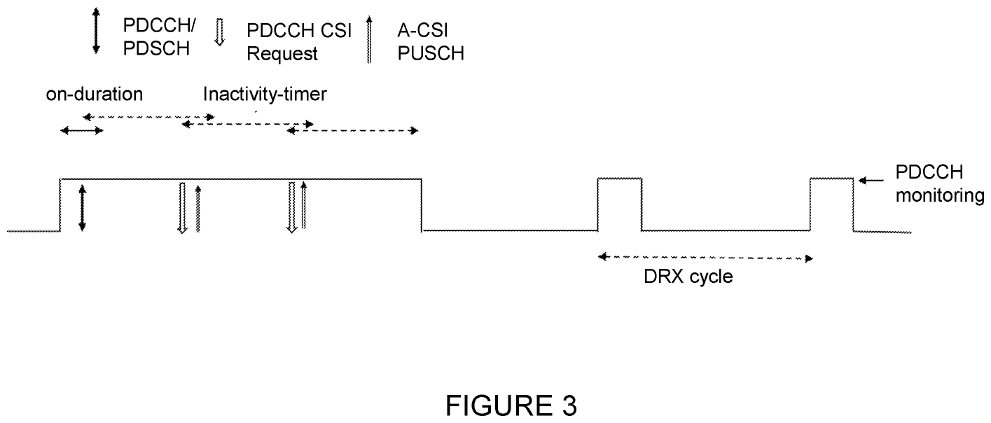

FIG. 4 illustrates a scenario using of DRX Command MAC CE to stop Information Element (IE) timers, according to certain embodiments;

FIG. 5 illustrates an example scenario where, even with DRX Command MAC CE, CSI requests keep a UE in short cycles longer than necessary;

FIG. 6 illustrates an example scenario for using a combination of MAC CE DRX and Long DRX Command MAC CEs to allow a UE to transition to long cycles, according to certain embodiments;

FIG. 7 illustrates a signalling diagram demonstrating conditions for transmitting DRX Command MAC CE or Long DRX Command MAC CE, according to certain embodiments;

FIG. 8 illustrates an example communication system, according to certain embodiments;

FIG. 9 illustrates an example UE, according to certain embodiments;

FIG. 10 illustrates an example network node, according to certain embodiments;

FIG. 11 illustrates a block diagram of a host, according to certain embodiments;

FIG. 12 illustrates a virtualization environment in which functions implemented by some embodiments may be virtualized, according to certain embodiments;

FIG. 13 illustrates a host communicating via a network node with a UE over a partially wireless connection, according to certain embodiments;

FIG. 14 illustrates a method by a network node for controlling a DRX state of a wireless device in a connected state, according to certain embodiments;

FIG. 15 illustrates an example method by a network node for controlling a DRX state of a wireless device in a connected state, according to certain embodiments; and

FIG. 16 illustrates an example method by a wireless device for controlling a DRX operation while in a connected state, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art.

As described above, DRX inactivity timers are typically re-started not only when new data UL and/or DL transmissions are granted but also when, for example, a PDCCH is received that only results in UE transmitting a CSI report and a BSR indicating that the buffer is empty. For the latter cases, it is unnecessary to restart the DRX inactivity timer; however, the current standard mandates that it should be restarted.

Accordingly, particular embodiments of the present disclosure may provide systems, methods, and techniques for not restarting timers when a wireless device such as a UE has a BSR of zero and/or transmits or receives user data. In certain embodiments, timers may be proprietary timers that are internal to a network node and/or UE.

According to certain embodiments, systems, methods, and techniques are also provided for configuring a wireless device via RRC signaling or MAC CE to not restart an inactivity timer when the wireless device has a BSR of zero and transmits or receives user data.

To solve this problem without standardization changes, certain embodiments define a new timer in the base station. The new timer may be referred to herein as a data-inactivity-timer, which functions similarly to the DRX-inactivity-timer but is not restarted when an associated PUSCH contains BSR=0. When the data-inactivity-timer expires, and a PUSH with BSR=0 has been sent after the last new data transmission, a MAC control element such as, for example, a DRX Command MAC CE, is transmitted to the UE. When this MAC control clement reaches the UE, the UE stops drx-onDurationTimer/drx-InactivityTimers. Every time a PUSCH without user data and with a BSR=0 is received from the UE, the base station also checks the status of the data-inactivity-timer. If this timer is not running, a DRX Command MAC CE is transmitted to stop the timers at the UE side. The base station then also needs to stop the DRX-inactivity-timer to ensure alignment with the UE DRX state.

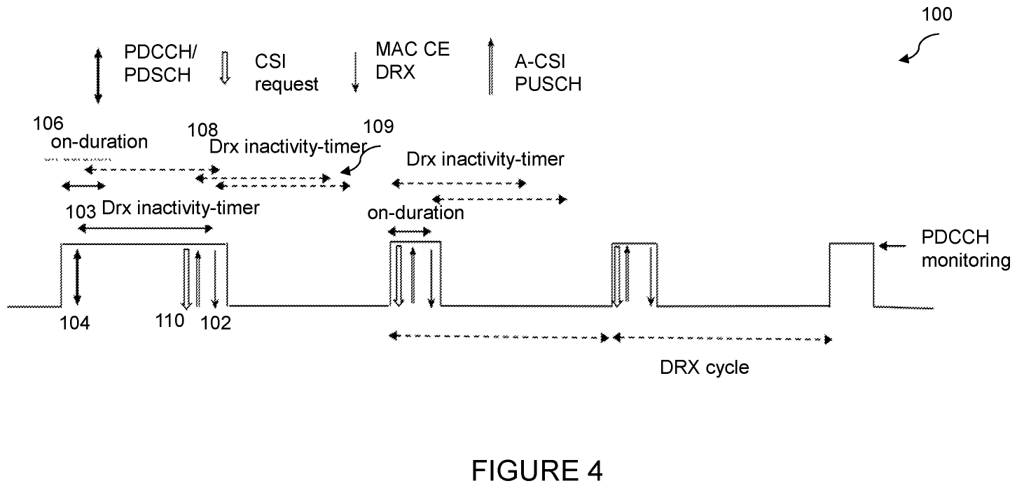

FIG. 4 illustrates a scenario 100 using of DRX Command MAC CE 102 to stop DRX inactivity timers, according to certain embodiments. As depicted, the drx-inactivity-timer 103 is started when a PDCCH or PDSCH 104 is transmitted during on-duration 106 and is stopped when a DRX Command Mac CE 102 is transmitted by the network node. If the DRX Command MAC CE 102 would not be transmitted, the DRX inactivity timer 108 would continue to run and the UE monitor the PDCCH until DRX inactivity timer expiry 109.

According to certain embodiments, one further condition may be checked. If the base station has received a Scheduling Request (SR) and has yet not scheduled the UE, or if another scheduled PUSCH transmission is pending, then no DRX Command MAC CE may be transmitted by the network node, in certain embodiments.

As described above, short and long cycles may be used as a way to gradually move a UE to a less active monitoring state. The long cycles are useful to reduce the power consumption during the time period before the UE is released from the RRC connected state to RRC idle (or inactive). However, if the UE is periodically asked to send CSI reports along with other data such as a BSR or Power Head Room (PHR), then the UE is kept in the short cycle and may not be able to enter the long cycle. Sending a DRX Command MAC CE is not enough. 3GPP 38.321 v 16.4.0 states:
if a DRX Command MAC CE or a Long DRX Command MAC CE is received:
   stop drx-onDurationTimer/drx-InactivityTimer.
   if the Short DRX cycle is configured:
      start or restart drx-ShortCycleTimer in the first symbol after the expiry of drx-InactivityTimer;
      use the Short DRX cycle.
         Thus, to enter the long cycle the short cycle timer needs to expire, but the short-cycle-timer is restarted after receiving the DRX Command MAC CE, as described above and shown in FIG. 4.

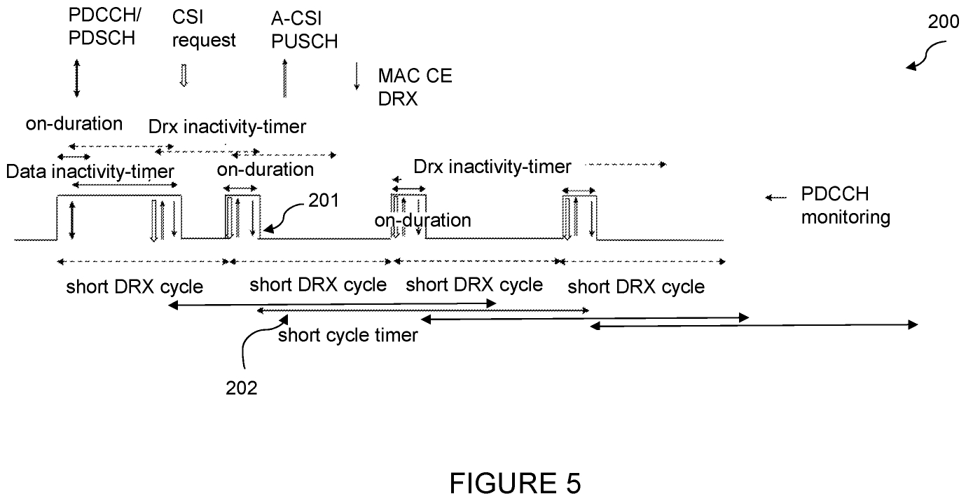

FIG. 5 illustrates an example scenario 200 that demonstrates that, even with DRX Command MAC CE, CSI requests keeps UE in short cycles longer than necessary. The UE stops the DRX inactivity timer at the reception of DRX Command MAC CE 201. At the same time it restarts the short-cycle-timer 202. The restart of the short-cycle timer occurs at all instances where DRX Command MAC CE is received.

Fortunately, there is also a Long DRX Command MAC CE which can be utilized according to 3GPP 38.321 v 16.4.0:
if a Long DRX Command MAC CE is received:
   stop drx-onDurationTimer/drx-InactivityTimer.
   stop drx-ShortCycleTimer;
   use the Long DRX cycle.

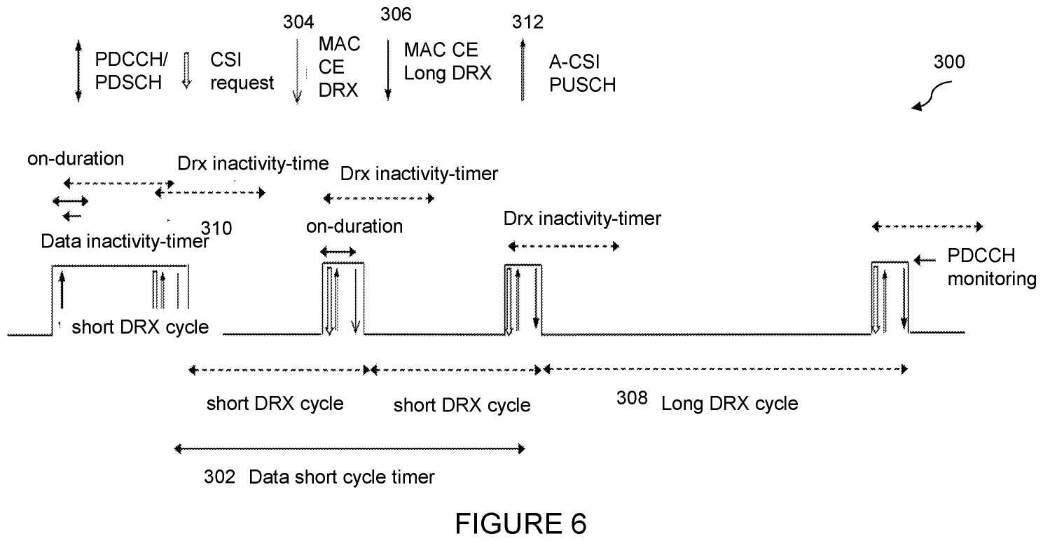

FIG. 6 illustrates a scenario 300 for using a combination of MAC CE DRX 304 and Long DRX Command MAC CEs 306 to allow a UE to transition to long cycles 308, according to certain embodiments. As depicted, a new timer is defined in the base station, which may be referred to herein as a data-short-cycle-timer and is shown at 302. According to certain embodiments, the data-short-cycle timer 302 is re-started when the data-inactivity-timer 310 expires. When the data-short-cycle-timer 302 expires and the base station has received a PUSCH transmission 312 with a BSR=0 after the last new data transmission, the base station schedules and transmits a Long DRX Command MAC CE 306 to the UE.

Furthermore, according to certain embodiments, if the base station receives a PUSCH transmission 312 with BSR=0 and the data-short-cycle-timers 302 and data-inactivity-timers 310 are not running, the base station schedules and transmits a Long DRX Command MAC CE 306 to the UE. The base station also stops the drx-Inactivity Timer and drx-ShortCycle Timer to ensure alignment with the UE DRX state. Otherwise, if the data-inactivity-timer 310 expires and the base station has received a PUSCH transmission 312 with BSR=0 after the last new data transmission, the DRX Command MAC CE is sent. If the data-inactivity-timer has expired but the data-short-cycle-timer is running and the base station receives a PUSCH transmission 310 with BSR=0, DRX Command MAC CE is sent.

Similar to as described above, some further conditions may be checked, in certain embodiments. For example, if the base station has received a SR and has yet not scheduled the UE, or if another scheduled PUSCH transmission is pending, then no DRX/Long DRX command MAC CE is transmitted.

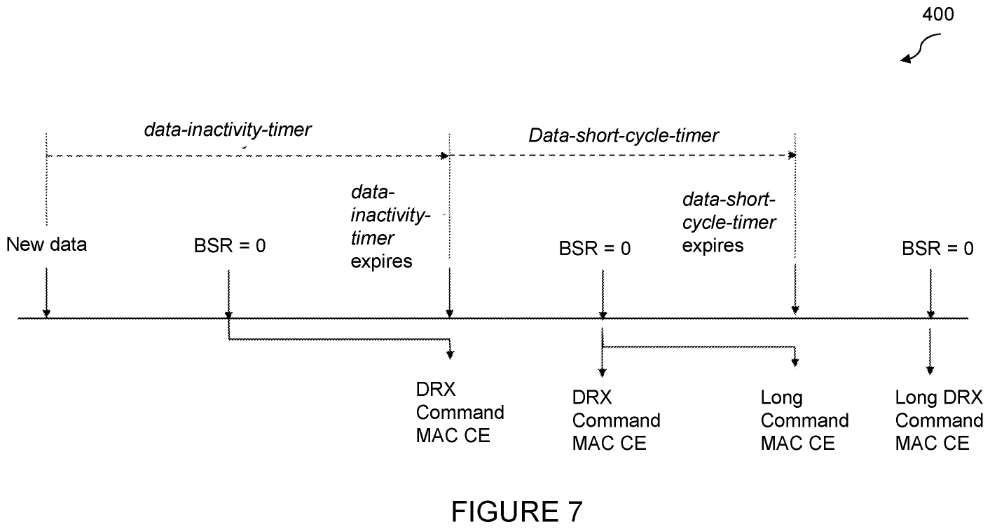

FIG. 7 illustrates a signalling diagram 400 demonstrating conditions for transmitting DRX Command MAC CE or Long DRX Command MAC CE, according to certain embodiments. As depicted, the relevant events are:
1. the reception of new data on PDSCH/PUSCH; this event (re-) starts the drx-InactivityTimer and the data-inactivity-timer,
2. the expiry of the data-inactivity-timer,
3. the expiry of the data-short-cycle-timer,
4. the transmission of PUSCH with BSR=0 report

Every time event 1 occurs the whole sequence is repeated so it is only necessary to model the chain of events as starting from event 1, in certain embodiments.

It may be noted that FIG. 7 depicts a BSR=0 report occurring after data-inactivity-timer has expired but while the data-short-cycle-timer is running. According to certain embodiments, this scenario results in two MAC CE transmissions: one DRX command followed by a Long DRX Command (unless of course if new data interrupts the sequence).

Some proprietary solutions are described above to address the problem that occurs when the UE transmits a CSI report and BSR and needs to restart its inactivity timer even though the BSR indicates that the UE data buffer is empty. According to certain other embodiments, an alternative solution may define a new RRC parameter in the DRX configuration that instructs the UE to not restart its inactivity timer when the associated PUSCH includes a BSR=0 report. The advantages of this solution are that no DL and UL resources need to be allocated for transmitting DRX Command MAC CE or Long DRX Command MAC CE after every granted PUSCH containing BSR=0 or when the data-short-cylce-timer expires.

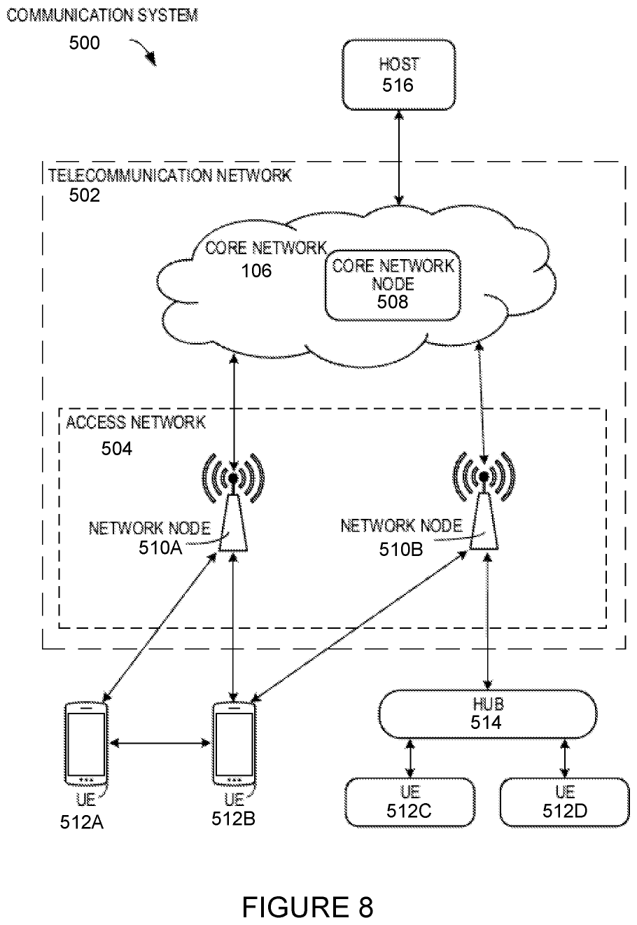

FIG. 8 shows an example of a communication system 500, in accordance with some embodiments. In the example, the communication system 500 includes a telecommunication network 502 that includes an access network 504, such as a radio access network (RAN), and a core network 506, which includes one or more core network nodes 508. The access network 504 includes one or more access network nodes, such as network nodes 510a and 510b (one or more of which may be generally referred to as network nodes 510), or any other similar 3^{rd} Generation Partnership Project (3GPP) access node or non-3GPP access point. The network nodes 510 facilitate direct or indirect connection of user equipment (UE), such as by connecting UEs 512a, 512b, 512c, and 512d (one or more of which may be generally referred to as UEs 512) to the core network 506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 500 may include any number of wired or wireless networks, network nodes, UEs, and/or any other components or systems that may facilitate or participate in the communication of data and/or signals whether via wired or wireless connections. The communication system 500 may include and/or interface with any type of communication, telecommunication, data, cellular, radio network, and/or other similar type of system.

The UEs 512 may be any of a wide variety of communication devices, including wireless devices arranged, configured, and/or operable to communicate wirelessly with the network nodes 510 and other communication devices. Similarly, the network nodes 510 are arranged, capable, configured, and/or operable to communicate directly or indirectly with the UEs 512 and/or with other network nodes or equipment in the telecommunication network 502 to enable and/or provide network access, such as wireless network access, and/or to perform other functions, such as administration in the telecommunication network 502.

In the depicted example, the core network 506 connects the network nodes 510 to one or more hosts, such as host 516. These connections may be direct or indirect via one or more intermediary networks or devices. In other examples, network nodes may be directly coupled to hosts. The core network 506 includes one more core network nodes (e.g., core network node 508) that are structured with hardware and software components. Features of these components may be substantially similar to those described with respect to the UEs, network nodes, and/or hosts, such that the descriptions thereof are generally applicable to the corresponding components of the core network node 508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 516 may be under the ownership or control of a service provider other than an operator or provider of the access network 504 and/or the telecommunication network 502, and may be operated by the service provider or on behalf of the service provider. The host 516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 500 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox. In some examples, the telecommunication network 502 is a cellular network that implements 3GPP standardized features. Accordingly, the telecommunications network 502 may support network slicing to provide different logical networks to different devices that are connected to the telecommunication network 502. For example, the telecommunications network 502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 512 are configured to transmit and/or receive information without direct human interaction. For instance, a UE may be designed to transmit information to the access network 504 on a predetermined schedule, when triggered by an internal or external event, or in response to requests from the access network 504. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 514 communicates with the access network 504 to facilitate indirect communication between one or more UEs (e.g., UE 512c and/or 512d) and network nodes (e.g., network node 510b). In some examples, the hub 514 may be a controller, router, content source and analytics, or any of the other communication devices described herein regarding UEs. For example, the hub 514 may be a broadband router enabling access to the core network 506 for the UEs. As another example, the hub 514 may be a controller that sends commands or instructions to one or more actuators in the UEs. Commands or instructions may be received from the UEs, network nodes 510, or by executable code, script, process, or other instructions in the hub 514. As another example, the hub 514 may be a data collector that acts as temporary storage for UE data and, in some embodiments, may perform analysis or other processing of the data. As another example, the hub 514 may be a content source. For example, for a UE that is a VR headset, display, loudspeaker or other media delivery device, the hub 514 may retrieve VR assets, video, audio, or other media or data related to sensory information via a network node, which the hub 514 then provides to the UE either directly, after performing local processing, and/or after adding additional local content. In still another example, the hub 514 acts as a proxy server or orchestrator for the UEs, in particular in if one or more of the UEs are low energy IoT devices.

The hub 514 may have a constant/persistent or intermittent connection to the network node 510b. The hub 514 may also allow for a different communication scheme and/or schedule between the hub 514 and UEs (e.g., UE 512c and/or 512d), and between the hub 514 and the core network 506. In other examples, the hub 514 is connected to the core network 506 and/or one or more UEs via a wired connection. Moreover, the hub 514 may be configured to connect to an M2M service provider over the access network 504 and/or to another UE over a direct connection. In some scenarios, UEs may establish a wireless connection with the network nodes 510 while still connected via the hub 514 via a wired or wireless connection. In some embodiments, the hub 514 may be a dedicated hub—that is, a hub whose primary function is to route communications to/from the UEs from/to the network node 510b. In other embodiments, the hub 514 may be a non-dedicated hub-that is, a device which is capable of operating to route communications between the UEs and network node 510b, but which is additionally capable of operating as a communication start and/or end point for certain data channels.

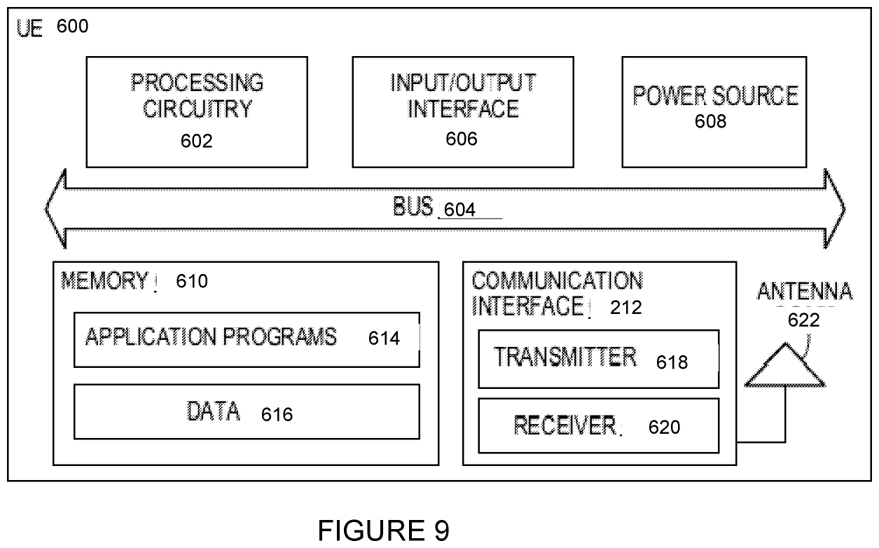

FIG. 9 shows a UE 600 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE. A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 600 includes processing circuitry 602 that is operatively coupled via a bus 604 to an input/output interface 606, a power source 608, a memory 610, a communication interface 612, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 602 is configured to process instructions and data and may be configured to implement any sequential state machine operative to execute instructions stored as machine-readable computer programs in the memory 610. The processing circuitry 602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 602 may include multiple central processing units (CPUs).

In the example, the input/output interface 606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 608 is structured as a battery or battery pack. Other types of power sources, such as an external power source (e.g., an electricity outlet), photovoltaic device, or power cell, may be used. The power source 608 may further include power circuitry for delivering power from the power source 608 itself, and/or an external power source, to the various parts of the UE 600 via input circuitry or an interface such as an electrical power cable. Delivering power may be, for example, for charging of the power source 608. Power circuitry may perform any formatting, converting, or other modification to the power from the power source 608 to make the power suitable for the respective components of the UE 600 to which power is supplied.

The memory 610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 610 includes one or more application programs 614, such as an operating system, web browser application, a widget, gadget engine, or other application, and corresponding data 616. The memory 610 may store, for use by the UE 600, any of a variety of various operating systems or combinations of operating systems.

The memory 610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 610 may allow the UE 600 to access instructions, application programs and the like, stored on transitory or non-transitory memory media, to off-load data, or to upload data. An article of manufacture, such as one utilizing a communication system may be tangibly embodied as or in the memory 610, which may be or comprise a device-readable storage medium.

The processing circuitry 602 may be configured to communicate with an access network or other network using the communication interface 612. The communication interface 612 may comprise one or more communication subsystems and may include or be communicatively coupled to an antenna 622. The communication interface 612 may include one or more transceivers used to communicate, such as by communicating with one or more remote transceivers of another device capable of wireless communication (e.g., another UE or a network node in an access network). Each transceiver may include a transmitter 618 and/or a receiver 620 appropriate to provide network communications (e.g., optical, electrical, frequency allocations, and so forth). Moreover, the transmitter 618 and receiver 620 may be coupled to one or more antennas (e.g., antenna 622) and may share circuit components, software or firmware, or alternatively be implemented separately.

In the illustrated embodiment, communication functions of the communication interface 612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 600 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

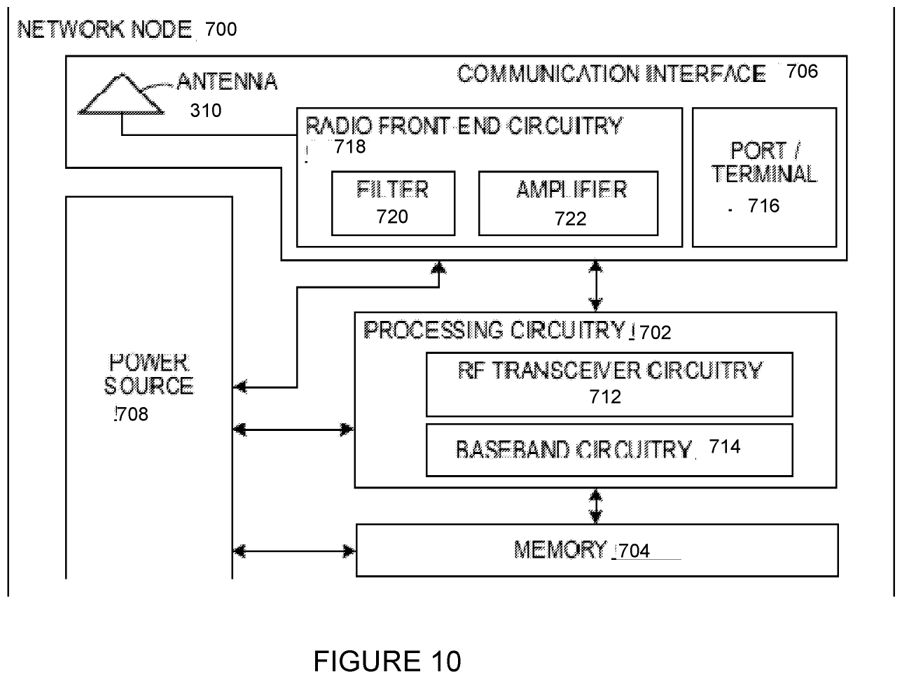

FIG. 10 shows a network node 700 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 700 includes a processing circuitry 702, a memory 704, a communication interface 706, and a power source 708. The network node 700 may be composed of multiple physically separate components (e.g., a NodeB component and a RNC component, or a BTS component and a BSC component, etc.), which may each have their own respective components. In certain scenarios in which the network node 700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 700 may be configured to support multiple radio access technologies (RATs). In such embodiments, some components may be duplicated (e.g., separate memory 704 for different RATs) and some components may be reused (e.g., a same antenna 710 may be shared by different RATs). The network node 700 may also include multiple sets of the various illustrated components for different wireless technologies integrated into network node 700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 700.

The processing circuitry 702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 700 components, such as the memory 704, to provide network node 700 functionality.

In some embodiments, the processing circuitry 702 includes a system on a chip (SOC). In some embodiments, the processing circuitry 702 includes one or more of radio frequency (RF) transceiver circuitry 712 and baseband processing circuitry 714. In some embodiments, the radio frequency (RF) transceiver circuitry 712 and the baseband processing circuitry 714 may be on separate chips (or sets of chips), boards, or units, such as radio units and digital units. In alternative embodiments, part or all of RF transceiver circuitry 712 and baseband processing circuitry 714 may be on the same chip or set of chips, boards, or units.

The memory 704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 702. The memory 704 may store any suitable instructions, data, or information, including a computer program, software, an application including one or more of logic, rules, code, tables, and/or other instructions capable of being executed by the processing circuitry 702 and utilized by the network node 700. The memory 704 may be used to store any calculations made by the processing circuitry 702 and/or any data received via the communication interface 706. In some embodiments, the processing circuitry 702 and memory 704 is integrated.

The communication interface 706 is used in wired or wireless communication of signaling and/or data between a network node, access network, and/or UE. As illustrated, the communication interface 706 comprises port(s)/terminal(s) 716 to send and receive data, for example to and from a network over a wired connection. The communication interface 706 also includes radio front-end circuitry 718 that may be coupled to, or in certain embodiments a part of, the antenna 710. Radio front-end circuitry 718 comprises filters 720 and amplifiers 722. The radio front-end circuitry 718 may be connected to an antenna 710 and processing circuitry 702. The radio front-end circuitry may be configured to condition signals communicated between antenna 710 and processing circuitry 702. The radio front-end circuitry 718 may receive digital data that is to be sent out to other network nodes or UEs via a wireless connection. The radio front-end circuitry 718 may convert the digital data into a radio signal having the appropriate channel and bandwidth parameters using a combination of filters 720 and/or amplifiers 722. The radio signal may then be transmitted via the antenna 710. Similarly, when receiving data, the antenna 710 may collect radio signals which are then converted into digital data by the radio front-end circuitry 718. The digital data may be passed to the processing circuitry 702. In other embodiments, the communication interface may comprise different components and/or different combinations of components.

In certain alternative embodiments, the network node 700 does not include separate radio front-end circuitry 718, instead, the processing circuitry 702 includes radio front-end circuitry and is connected to the antenna 710. Similarly, in some embodiments, all or some of the RF transceiver circuitry 712 is part of the communication interface 706. In still other embodiments, the communication interface 706 includes one or more ports or terminals 716, the radio front-end circuitry 718, and the RF transceiver circuitry 712, as part of a radio unit (not shown), and the communication interface 706 communicates with the baseband processing circuitry 714, which is part of a digital unit (not shown).

The antenna 710 may include one or more antennas, or antenna arrays, configured to send and/or receive wireless signals. The antenna 710 may be coupled to the radio front-end circuitry 718 and may be any type of antenna capable of transmitting and receiving data and/or signals wirelessly. In certain embodiments, the antenna 710 is separate from the network node 700 and connectable to the network node 700 through an interface or port.

The antenna 710, communication interface 706, and/or the processing circuitry 702 may be configured to perform any receiving operations and/or certain obtaining operations described herein as being performed by the network node. Any information, data and/or signals may be received from a UE, another network node and/or any other network equipment. Similarly, the antenna 710, the communication interface 706, and/or the processing circuitry 702 may be configured to perform any transmitting operations described herein as being performed by the network node. Any information, data and/or signals may be transmitted to a UE, another network node and/or any other network equipment.

The power source 708 provides power to the various components of network node 700 in a form suitable for the respective components (e.g., at a voltage and current level needed for each respective component). The power source 708 may further comprise, or be coupled to, power management circuitry to supply the components of the network node 700 with power for performing the functionality described herein. For example, the network node 700 may be connectable to an external power source (e.g., the power grid, an electricity outlet) via an input circuitry or interface such as an electrical cable, whereby the external power source supplies power to power circuitry of the power source 708. As a further example, the power source 708 may comprise a source of power in the form of a battery or battery pack which is connected to, or integrated in, power circuitry. The battery may provide backup power should the external power source fail.

Embodiments of the network node 700 may include additional components beyond those shown in FIG. 10 for providing certain aspects of the network node's functionality, including any of the functionality described herein and/or any functionality necessary to support the subject matter described herein. For example, the network node 700 may include user interface equipment to allow input of information into the network node 700 and to allow output of information from the network node 700. This may allow a user to perform diagnostic, maintenance, repair, and other administrative functions for the network node 700.

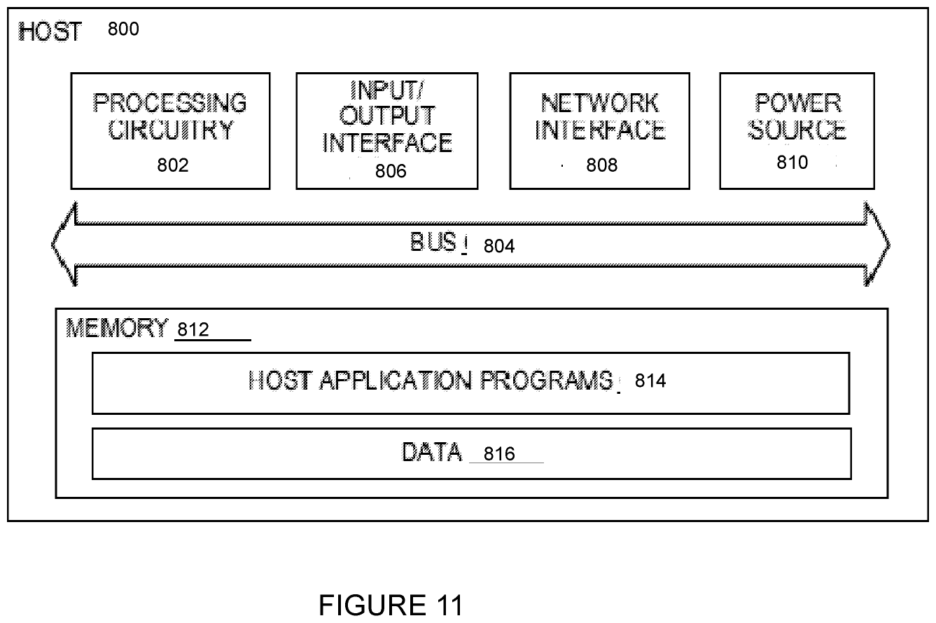

FIG. 11 is a block diagram of a host 800, which may be an embodiment of the host 516 of FIG. 8, in accordance with various aspects described herein. As used herein, the host 800 may be or comprise various combinations hardware and/or software, including a standalone server, a blade server, a cloud-implemented server, a distributed server, a virtual machine, container, or processing resources in a server farm. The host 800 may provide one or more services to one or more UEs.

The host 800 includes processing circuitry 802 that is operatively coupled via a bus 804 to an input/output interface 806, a network interface 808, a power source 810, and a memory 812. Other components may be included in other embodiments. Features of these components may be substantially similar to those described with respect to the devices of previous figures, such as FIGS. 6 and 7, such that the descriptions thereof are generally applicable to the corresponding components of host 800.

The memory 812 may include one or more computer programs including one or more host application programs 814 and data 816, which may include user data, e.g., data generated by a UE for the host 800 or data generated by the host 800 for a UE. Embodiments of the host 800 may utilize only a subset or all of the components shown. The host application programs 814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 814 may also provide for user authentication and licensing checks and may periodically report health, routes, and content availability to a central node, such as a device in or on the edge of a core network. Accordingly, the host 800 may select and/or indicate a different host for over-the-top services for a UE. The host application programs 814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

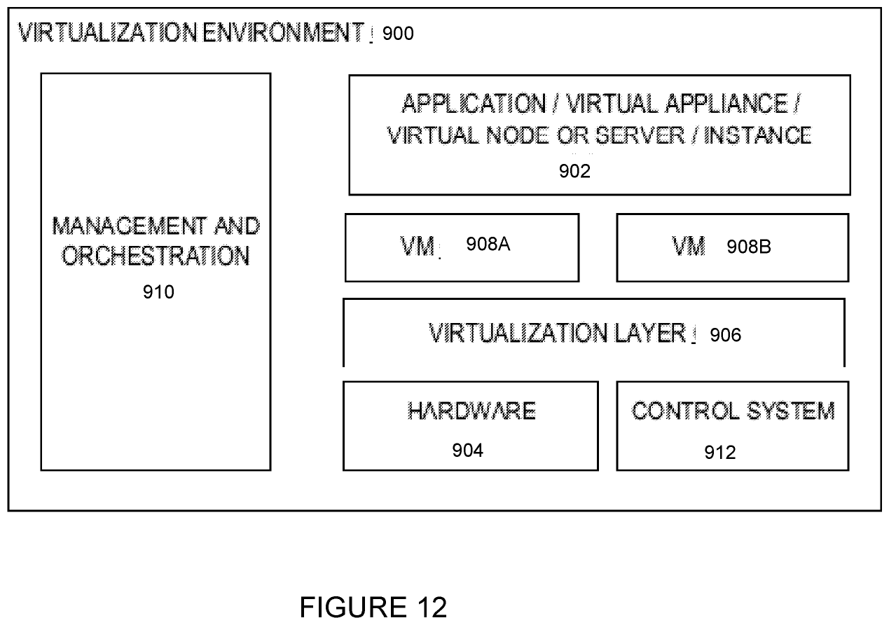

FIG. 12 is a block diagram illustrating a virtualization environment 900 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 902 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908a and 908b (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g. such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 912 which may alternatively be used for communication between hardware nodes and radio units.

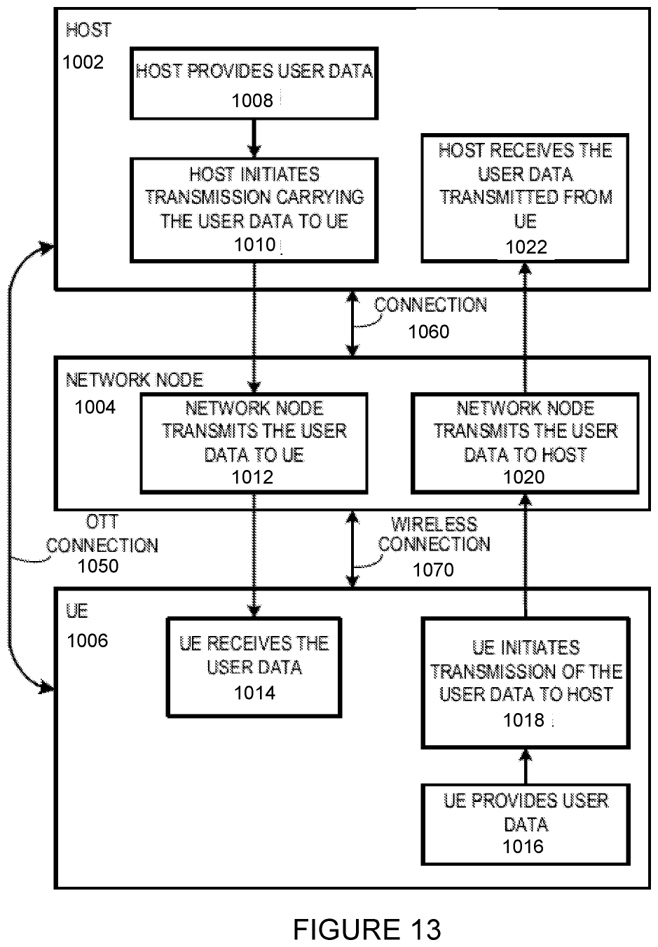

FIG. 13 shows a communication diagram of a host 1002 communicating via a network node 1004 with a UE 1006 over a partially wireless connection in accordance with some embodiments.

Example implementations, in accordance with various embodiments, of the UE (such as a UE 512a of FIG. 8 and/or UE 600 of FIG. 9), network node (such as network node 510a of FIG. 8 and/or network node 700 of FIG. 10), and host (such as host 516 of FIG. 8 and/or host 800 of FIG. 11) discussed in the preceding paragraphs will now be described with reference to FIG. 13.

Like host 800, embodiments of host 1002 include hardware, such as a communication interface, processing circuitry, and memory. The host 1002 also includes software, which is stored in or accessible by the host 1002 and executable by the processing circuitry. The software includes a host application that may be operable to provide a service to a remote user, such as the UE 1006 connecting via an over-the-top (OTT) connection 1050 extending between the UE 1006 and host 1002. In providing the service to the remote user, a host application may provide user data which is transmitted using the OTT connection 1050.

The network node 1004 includes hardware enabling it to communicate with the host 1002 and UE 1006. The connection 1060 may be direct or pass through a core network (like core network 506 of FIG. 8) and/or one or more other intermediate networks, such as one or more public, private, or hosted networks. For example, an intermediate network may be a backbone network or the Internet.

The UE 1006 includes hardware and software, which is stored in or accessible by UE 1006 and executable by the UE's processing circuitry. The software includes a client application, such as a web browser or operator-specific “app” that may be operable to provide a service to a human or non-human user via UE 1006 with the support of the host 1002. In the host 1002, an executing host application may communicate with the executing client application via the OTT connection 1050 terminating at the UE 1006 and host 1002. In providing the service to the user, the UE's client application may receive request data from the host's host application and provide user data in response to the request data. The OTT connection 1050 may transfer both the request data and the user data. The UE's client application may interact with the user to generate the user data that it provides to the host application through the OTT connection 1050.

The OTT connection 1050 may extend via a connection 1060 between the host 1002 and the network node 1004 and via a wireless connection 1070 between the network node 1004 and the UE 1006 to provide the connection between the host 1002 and the UE 1006. The connection 1060 and wireless connection 1070, over which the OTT connection 1050 may be provided, have been drawn abstractly to illustrate the communication between the host 1002 and the UE 1006 via the network node 1004, without explicit reference to any intermediary devices and the precise routing of messages via these devices.

As an example of transmitting data via the OTT connection 1050, in step 1008, the host 1002 provides user data, which may be performed by executing a host application. In some embodiments, the user data is associated with a particular human user interacting with the UE 1006. In other embodiments, the user data is associated with a UE 1006 that shares data with the host 1002 without explicit human interaction. In step 1010, the host 1002 initiates a transmission carrying the user data towards the UE 1006. The host 1002 may initiate the transmission responsive to a request transmitted by the UE 1006. The request may be caused by human interaction with the UE 1006 or by operation of the client application executing on the UE 1006. The transmission may pass via the network node 1004, in accordance with the teachings of the embodiments described throughout this disclosure. Accordingly, in step 1012, the network node 1004 transmits to the UE 1006 the user data that was carried in the transmission that the host 1002 initiated, in accordance with the teachings of the embodiments described throughout this disclosure. In step 1014, the UE 1006 receives the user data carried in the transmission, which may be performed by a client application executed on the UE 1006 associated with the host application executed by the host 1002.

In some examples, the UE 1006 executes a client application which provides user data to the host 1002. The user data may be provided in reaction or response to the data received from the host 1002. Accordingly, in step 1016, the UE 1006 may provide user data, which may be performed by executing the client application. In providing the user data, the client application may further consider user input received from the user via an input/output interface of the UE 1006. Regardless of the specific manner in which the user data was provided, the UE 1006 initiates, in step 1018, transmission of the user data towards the host 1002 via the network node 1004. In step 1020, in accordance with the teachings of the embodiments described throughout this disclosure, the network node 1004 receives user data from the UE 1006 and initiates transmission of the received user data towards the host 1002. In step 1022, the host 1002 receives the user data carried in the transmission initiated by the UE 1006.

One or more of the various embodiments improve the performance of OTT services provided to the UE 1006 using the OTT connection 1050, in which the wireless connection 1070 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 1002. As another example, the host 1002 may process audio and video data which may have been retrieved from a UE for use in creating maps. As another example, the host 1002 may collect and analyze real-time data to assist in controlling vehicle congestion (e.g., controlling traffic lights). As another example, the host 1002 may store surveillance video uploaded by a UE. As another example, the host 1002 may store or control access to media content such as video, audio, VR or AR which it can broadcast, multicast or unicast to UEs. As other examples, the host 1002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1050 between the host 1002 and UE 1006, in response to variations in the measurement results. The measurement procedure and/or the network functionality for reconfiguring the OTT connection may be implemented in software and hardware of the host 1002 and/or UE 1006. In some embodiments, sensors (not shown) may be deployed in or in association with other devices through which the OTT connection 1050 passes; the sensors may participate in the measurement procedure by supplying values of the monitored quantities exemplified above, or supplying values of other physical quantities from which software may compute or estimate the monitored quantities. The reconfiguring of the OTT connection 1050 may include message format, retransmission settings, preferred routing etc.; the reconfiguring need not directly alter the operation of the network node 1004. Such procedures and functionalities may be known and practiced in the art. In certain embodiments, measurements may involve proprietary UE signaling that facilitates measurements of throughput, propagation times, latency and the like, by the host 1002. The measurements may be implemented in that software causes messages to be transmitted, in particular empty or ‘dummy’ messages, using the OTT connection 1050 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

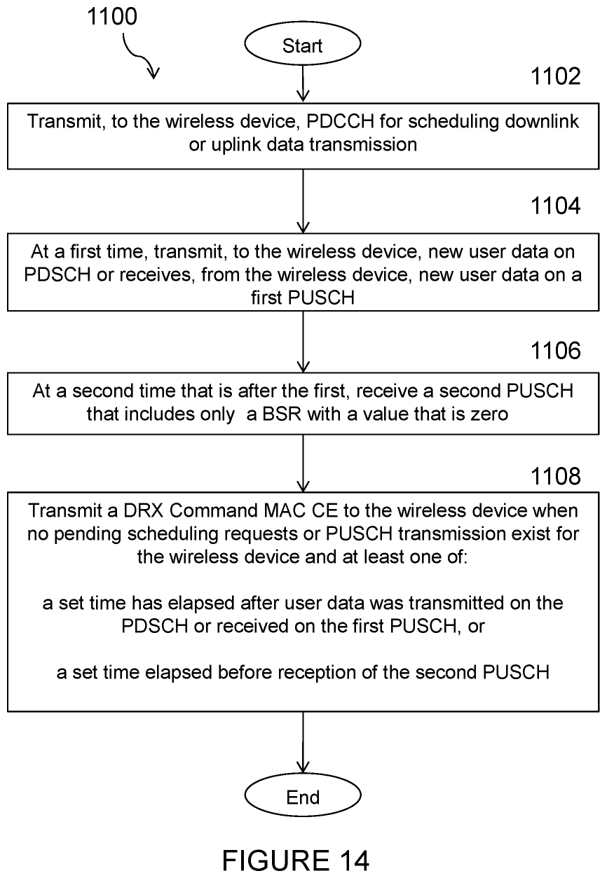

FIG. 14 illustrates a method 1100 by a network node 510 for controlling a DRX state of a wireless device such as a UE 512 in a connected state, according to certain embodiments. The wireless device 512 is configured with a long DRX cycle. The method begins at step 1102 when the network node 510 transmits, to the wireless device 512, PDCCH for scheduling DL or UL data transmission. At step 1104 and at a first time, the network node 510 transmits new user data to wireless device 512 on a PDSCH or the receives new user data from the wireless device 512 on a first PUSCH. At step 1106, and at a second time that is after the first, the network node 510 receives a second PUSCH that includes only a BSR with a value that is zero. At step 1108, the network node 510 transmits a DRX Command MAC CE to the wireless device 512 when no pending scheduling requests or PUSCH transmission exist for the wireless device 512 and at least one of: a set time has elapsed after user data was transmitted on the PDSCH or received on the first PUSCH, or a set time elapsed before reception of the second PUSCH. In a particular embodiment, the network node 510 starts an data inactivity timer when new data is transmitted on the PDSCH. Alternatively, the network node 510 starts the data inactivity timer in response to receiving the user data in the first PUSCH when the first PUSCH includes a BSR with a value that is greater than zero.

In a particular embodiment, an expiration of the data-inactivity-timer corresponds with the set time having elapsed after the user data is transmitted on the PDSCH or received in the first PUSCH or before the reception of the second PUSCH.

In a particular embodiment, upon expiration of the data-inactivity-timer, the network node 510 starts a data-short-cycle-timer. The network node 510 transmits a long DRX

Command MAC CE to the wireless if the data-inactivity timer is not running and no pending scheduling requests or PUSCH transmission exist for the wireless device and at least one of: the data-short-cycle-timer expires and a third PUSCH includes a BSR value of 0 after a last new data transmission, or the data-short-cycle-timer is not running and the third PUSCH includes a BSR value of 0.

In a particular embodiment, the wireless device is configured with a long and a short DRX cycle.

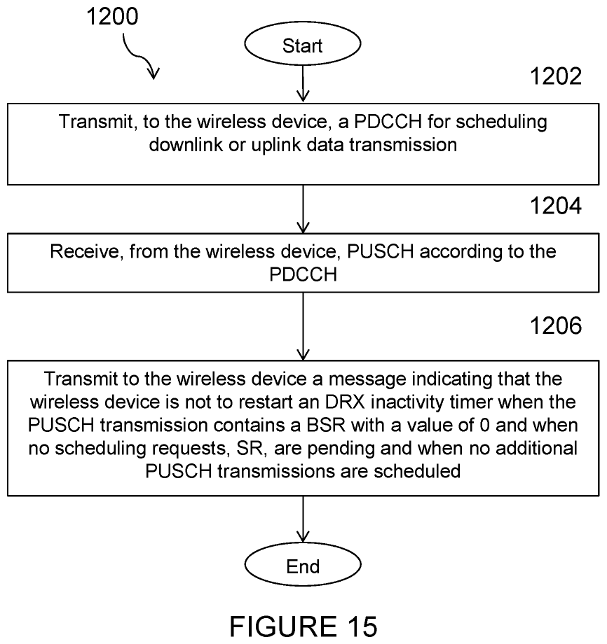

FIG. 15 illustrates an example method 1200 by a network node 510 for controlling a DRX state of a wireless device such as a UE 512 in a connected state, according to certain embodiments. The wireless is configured with a long DRX cycle. The method begins when the network node 510 transmits, to the wireless device 512, a PDCCH for scheduling DL or UL data transmission. At step 1204, the network node 510 receives, from the wireless device 512, PUSCH according to the PDCCH. At step 1206, the network node 510 transmits, to the wireless device 512, a message indicating that the wireless device is not to restart an DRX inactivity timer when the PUSCH transmission contains a BSR with a value of 0 and when no SRs are pending and when no additional PUSCH transmissions are scheduled.

In a particular embodiment, the message comprises a RRC message.

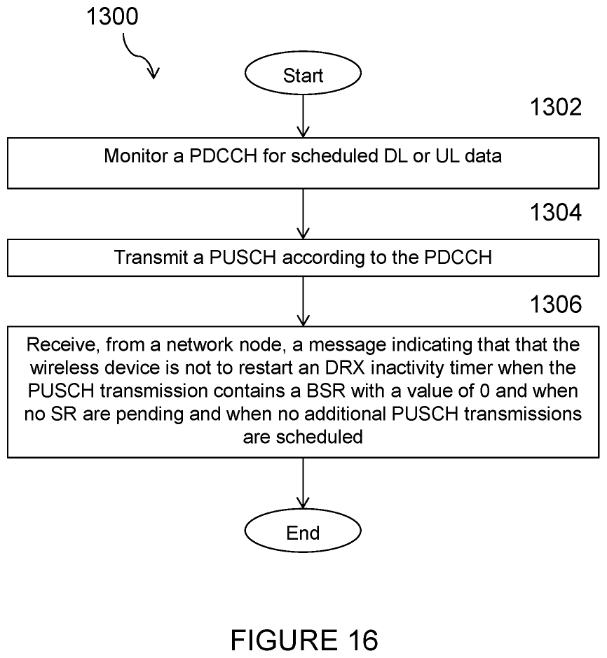

FIG. 16 illustrates an example method 1300 by a wireless device such as, for example a UE 512, for controlling a DRX operation while in a connected state, according to certain embodiments. The wireless device is with a long DRX cycle. The method begins at step 1302 with the wireless device 512 monitoring a PDCCH for scheduled DL or UL data. At step 1304, the wireless device 512 transmits a PUSCH according to the PDCCH. At step 1306, the wireless device 512 receives, from a network node 510, a message indicating that that the wireless device 512 is not to restart an DRX inactivity timer when the PUSCH transmission contains a BSR with a value of 0 and when no SRs are pending and when no additional PUSCH transmissions are scheduled.

In a particular embodiment, the message comprises a RRC message.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

1. A method by a network node for controlling a Discontinuous Reception, DRX, state of a wireless device in a connected state, the wireless device being configured with a long DRX cycle, the method comprising:
transmitting, to the wireless device, physical downlink control channel, PDCCH, for scheduling downlink or uplink data transmission;
at a first time, transmitting, to the wireless device, new user data on a physical downlink shared channel, PDSCH, or receiving, from the wireless device, new user data on a first physical uplink shared channel, PUSCH;
at a second time that is after the first, receiving a second PUSCH that includes only a Buffer Status Report, BSR, with a value that is zero; and
transmitting a DRX Command Medium Access Command-Control Element, MAC CE, to the wireless device when no pending scheduling requests or PUSCH transmission exist for the wireless device and at least one of:
a set time has elapsed after user data was transmitted on the PDSCH or received on the first PUSCH, or
a set time elapsed before reception of the second PUSCH.

2. The method of claim 1, further comprising starting an data inactivity timer when:
new data is transmitted on the PDSCH, or
in response to receiving the user data in the first PUSCH when the first PUSCH includes a BSR with a value that is greater than zero.

3. The method of claim 2, wherein an expiration of the data-inactivity-timer corresponds with the set time having elapsed after the user data is transmitted on the PDSCH or received in the first PUSCH or before the reception of the second PUSCH.

4. The method of claim 2, further comprising:
upon expiration of the data-inactivity-timer, starting a data-short-cycle-timer;
transmitting a long DRX Command MAC CE to the wireless if the data-inactivity timer is not running and no pending scheduling requests or PUSCH transmission exist for the wireless device and at least one of:
the data-short-cycle-timer expires and a third PUSCH includes a BSR value of 0 after a last new data transmission, or
the data-short-cycle-timer is not running and the third PUSCH includes a BSR value of 0.

5. The method of claim 1, wherein the wireless device is configured with a long and a short DRX cycle.

6. A method by a network node for controlling a Discontinuous Reception, DRX, state of a wireless device in a connected state, the wireless device being configured with a long DRX cycle, the method comprising:
transmitting, to the wireless device, a physical downlink control channel, PDCCH, for scheduling downlink or uplink data transmission;
receiving, from the wireless device, physical uplink shared channel, PUSCH, according to the PDCCH;
transmitting, to the wireless device, a message indicating that the wireless device is not to restart an DRX inactivity timer when the PUSCH transmission contains a Buffer Status Report, BSR, with a value of 0 and when no scheduling requests, SR, are pending and when no additional PUSCH transmissions are scheduled.

7. The method of claim 6, wherein the message comprises a Radio Resource Control message.

8. A method by a wireless device for controlling a Discontinuous Reception, DRX, operation while in a connected state, the wireless device being configured with a long DRX cycle, the method comprising:
monitoring a physical downlink control channel, PDCCH, for scheduled downlink, DL, or uplink, UL, data;
transmitting a physical uplink shared channel, PUSCH, according to the PDCCH;
receiving, from a network node, a message indicating that that the wireless device is not to restart an DRX inactivity timer when the PUSCH transmission contains a Buffer Status Report, BSR, with a value of 0 and when no scheduling requests, SR, are pending and when no additional PUSCH transmissions are scheduled.

9. The method of claim 8, wherein the message comprises a Radio Resource Control message.

10. A network node for controlling a Discontinuous Reception, DRX, state of a wireless device in a connected state, the wireless device being configured with a long DRX cycle, the network node adapted to:
transmit, to the wireless device, physical downlink control channel, PDCCH, for scheduling downlink or uplink data transmission;
at a first time, transmit, to the wireless device, new user data on the physical downlink shared channel, PDSCH, or receive, from the wireless device, new user data on a first physical uplink shared channel, PUSCH;
at a second time that is after the first, receive a second PUSCH that includes only a Buffer Status Report, BSR, with a value that is zero; and
transmit a DRX Command Medium Access Command-Control Element, MAC CE, to the wireless device when no pending scheduling requests or PUSCH transmission exist for the wireless device and at least one of:
a set time has elapsed after the new user data was transmitted on the PDSCH or received on the first PUSCH, or
a set time elapsed before reception of the second PUSCH.

11. The network node of claim 10, wherein the network node is adapted to start an data inactivity timer when:
new data is transmitted on the PDSCH, or
in response to receiving the user data in the first PUSCH when the first PUSCH includes a BSR with a value that is greater than zero.

12. The network node of claim 11, wherein an expiration of the data-inactivity-timer corresponds with the set time having elapsed after the user data is transmitted on the PDSCH or received in the first PUSCH or before the reception of the second PUSCH.

13. The network node of claim 11, wherein the network node is adapted to:
upon expiration of the data-inactivity-timer, start a data-short-cycle-timer;
transmit a long DRX Command MAC CE to the wireless if the data-inactivity timer is not running and no pending scheduling requests or PUSCH transmission exist for the wireless device and at least one of:
the data-short-cycle-timer expires and a third PUSCH includes a BSR value of 0 after a last new data transmission, or
the data-short-cycle-timer is not running and the third PUSCH includes a BSR value of 0.

14. The method of claim 10, wherein the wireless device is configured with a long and a short DRX cycle.

15. A network node for controlling a Discontinuous Reception, DRX, state of a wireless device in a connected state, the wireless device being configured with a long DRX cycle, the network node adapted to:
transmit, to the wireless device, a physical downlink control channel, PDCCH, for scheduling downlink or uplink data transmission;
receive, from the wireless device, physical uplink shared channel, PUSCH, according to the PDCCH;
transmit, to the wireless device, a message indicating that the wireless device is not to restart an DRX inactivity timer when the PUSCH transmission contains a Buffer Status Report, BSR, with a value of 0 and when no scheduling requests, SR, are pending and when no additional PUSCH transmissions are scheduled.

16. The network node of claim 15, wherein the message comprises a Radio Resource Control message.

17. A wireless device for controlling a Discontinuous Reception, DRX, operation while in a connected state, the wireless device being configured with a long DRX cycle, the wireless device adapted to:
monitor a physical downlink control channel, PDCCH, for scheduled downlink, DL, or uplink, UL, data;
transmit a physical uplink shared channel, PUSCH, according to the PDCCH;
receive, from a network node, a message indicating that that the wireless device is not to restart an DRX inactivity timer when the PUSCH transmission contains a Buffer Status Report, BSR, with a value of 0 and when no scheduling requests, SR, are pending and when no additional PUSCH transmissions are scheduled.

18. The wireless device of claim 17, wherein the message comprises a Radio Resource Control message.
